(19) United States
(12) Patent Application Publication
(10) Pub. No.: US 2010/0228590 A1
(43) Pub. Date: Sep. 9, 2010

(54) CONTEXT-AWARE ELECTRONIC SOCIAL NETWORKING

(75) Inventors: Samuel Muller, Zurich (CH); Dieter M. Sommer, Zurich (CH)

Correspondence Address: CANTOR COLBURN LLP-IBM YORKTOWN, 20 Church Street, 22nd Floor, Hartford, CT, 06103, US

(73) Assignee: International Business Machines Corporation, Armonk, NY (US)

(21) Appl. No.: 12/396,833

(22) Filed: Mar. 3, 2009

(51) Int. Cl. G06Q 10/00; G06Q 99/00; G06N 5/04; G06N 5/02

(52) U.S. Cl. 705/10; 706/46

(57) ABSTRACT

A computer-implemented method for performing context-aware social networking within an electronic social network is provided. The method includes dynamically obtaining context information corresponding to at least one of past, present and future events associated with each user of a plurality of users within the electronic social network, storing the obtained context information, defining one or more context patterns of interest using the stored context information, and detecting a context pattern of interest from the one or more context patterns of interest for a first user of the plurality of users and formulating one or more recommendations or executing user-defined actions or predefined actions by the electronic social network for the first user using the detected context pattern of interest and the context information of at least a second user of the plurality of users.

### BACKGROUND

This invention relates to electronic social networking and, in particular, to context-aware electronic social networking.

Today people organize a large portion of their daily private and business lives using electronic tools and the Internet. For example, many people use e-mail, electronic address books and calendars, electronic messaging tools such as Skype™, MSN Messenger™, Sametime™, and customer relationship management systems to communicate with their friends, partners, business associates, and acquaintances to plan trips, store and organize their contacts, manage their time, and execute online purchasing transactions. An increasing number of Internet users also participate in electronic social networks (ESNs). ESNs are provided and operated by dedicated electronic social networking platforms (ESNPs) such as Linkedln™, Xing™, and Facebook™. The ESNPs keep track of relationships between users and allow for decentralized profile management. Thus, every user of an ESNP manages only his or her personal data and connections, a subset of which is then automatically shared with his or her contacts.

While many presently existing electronic tools have been integrated, such as by combining email, address book, and calendar functionality, these tools are very loosely connected to ESNPs. As a result, a plethora of potentially useful information is not effectively shared among users, thereby limiting desired social interaction. For example, if a user is taking a vacation to Paris and would like to find out if any of his or her private contacts are going to be in Paris during his or her vacation, the user may choose to send an email to all of his or her friends letting them know about the user's plans. However, this approach results in a lot of inefficient communication overhead.

The present lack of integration between electronic tools and ESNs places significantly limits social interaction and results in an inadequate electronic representation of real world social relationships. This hinders an even larger-scale adoption of ESNs and diminishes the value that individual users are able to extract from ESNs.

### SUMMARY

The foregoing example illustrates the point that many opportunities for social contact, such as meeting old friends that happen to be in the same city, are frequently missed because providing the relevant context information would involve considerable communications overhead.

According to an embodiment of the present invention, a computer-implemented method for performing context-aware social networking within an electronic social network is provided. The method includes dynamically obtaining context information corresponding to at least one of past, present and future events associated with each user of a plurality of users within the electronic social network, storing the obtained context information, defining one or more context patterns of interest using the stored context information, and detecting a context pattern of interest from the one or more context patterns of interest for a first user of the plurality of users and formulating one or more recommendations or executing user-defined actions or predefined actions by the electronic social network for the first user using the detected context pattern of interest and the context information of at least a second user of the plurality of users.

A system and computer program product corresponding to the above-summarized method are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification.

The foregoing and other objects, features, and advantages of the invention are apparent from the following detailed description taken in conjunction with the accompanying drawings in which:

FIG. 1 is a schematic diagram illustrating an electronic social network (ESN) system that can be implemented within embodiments of the present invention.

FIG. 2 is a flowchart illustrating a method for performing context-aware social networking within an electronic social network that can be implemented within embodiments of the present invention.

FIG. 3 is a block diagram illustrating a general purpose computer that can be implemented within embodiments of the present invention.

The detailed description explains the preferred embodiments of the invention, together with advantages and features, by way of example with reference to the drawings.

### DETAILED DESCRIPTION

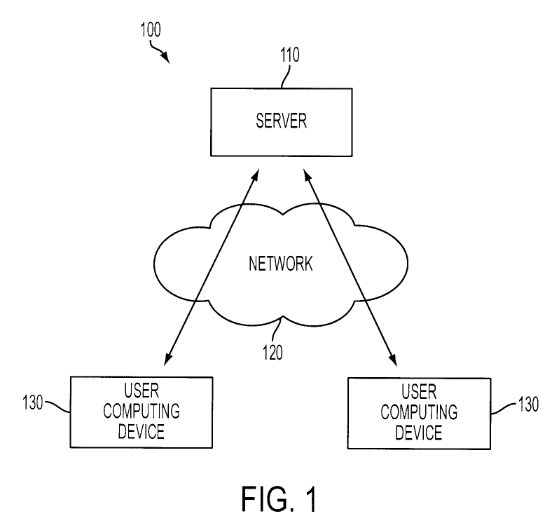

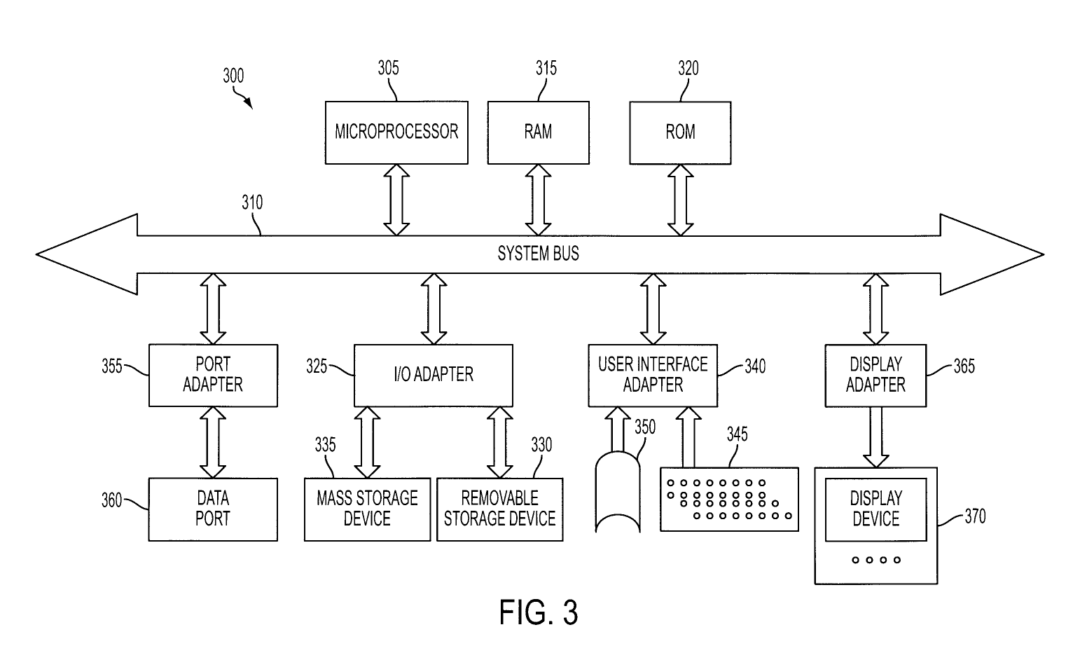

With reference now to FIG. 1, there is an electronic social network (ESN) system that can be implemented within embodiments of the present invention. As shown in FIG. 1, an ESN system 100 includes at least one server 110, a network 120 and user interfaces such as user computing devices 130 in communication with the server 110 via the network 120. The user computing devices 130 may be general computers (as depicted in FIG. 3), mobile computing devices such as notebooks, personal digital assistants (PDAs), and smart phones, for example. The network 120 may include, for example, the Internet, an intranet or any other suitable communication medium. The server 110 is shown as a separate processing unit; however, the functions of the server 110 may be performed via one of or a combination of the user computing devices 130, for example. The server 110 is capable of handling heavy loads including several users and employs technology platforms such as Java™ 2, Enterprise Edition (J2EE) or Microsoft™.Net, for example.

The method embodiments disclosed herein use the aforementioned computing devices to perform ‘context-aware electronic social networking’. In particular, past, present, and future contextual user information is leveraged to provide and inform other electronic social networking platform (ESNP) users about past, present, and future moods, activities, locations, time zones, and other geographic information, and to provide suggestions to these users based on such information. The ESNP users' privacy settings allow the sharing of their personal information to enable context-aware electronic social networking according to embodiments of the present invention. Further, the shared information becomes accessible to a subset of a respective user's contacts and not to everyone on the network such as the Internet.

At any given time, each user in an ESN may operate in a number of different contexts. According to an embodiment of the present invention, a context may be defined in terms of a location (e.g., actual geographic location, planned travel destination, previous location, etc.), an activity (e.g., watching a movie, communicating through e-mail, engaging in a Voice over Internet protocol (VoIP) call, writing real-time messages, visiting a museum, etc.), a type or category of time (e.g., spare time, working time, lunch time, commuting, free/busy calendar time, current time zone, etc.), societal status (e.g., private, business, role, etc.), or mood (e.g., happy, sad, tired, bored, active, etc.), or any of various combinations thereof. According to an embodiment of the present invention, any of the foregoing contexts may include sub-contexts. An example of a sub-context of the societal status ‘business’ mentioned above is the actual business role under which some business activity is performed. For example, an ESN user currently active in the ‘business’ context might first prepare a report in the role of a technical expert for a member of a board and then the same ESN user may later act in the role of a manager when interacting with the technical expert team that he leads. As another example, the context ‘spare time’ could be further refined into sub-contexts such as ‘family time’, ‘hobby time’ (e.g., for gardening, etc.), or ‘sports time’. Further, relationships and attributes between the contexts are typically modeled as ontologies, which are agreed upon and shared between the ESNP and external parties.

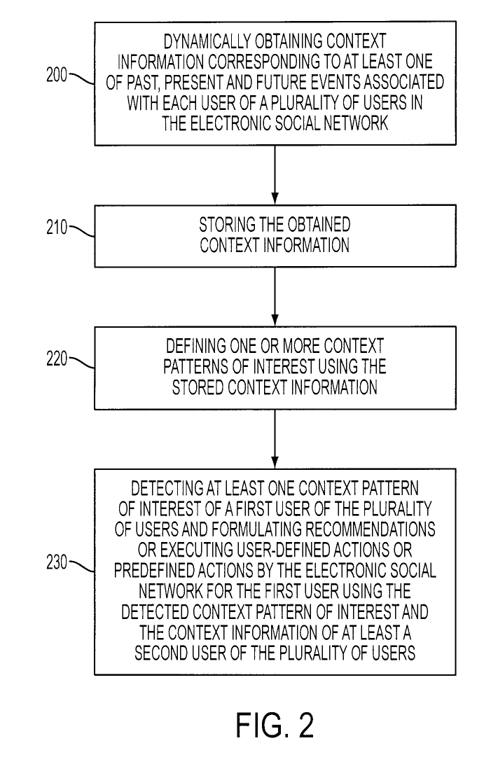

Over time, historic context information such as the information that a user u was in Paris, France yesterday, may be built up and stored in the ESNP. Therefore, as users plan future activities, tentative future contexts are being created (e.g., user u is going to/planning to be in Paris next week). Future context information implied by upcoming events and meetings scheduled in a user's calendar, is made available in an appropriate manner. In addition, past context information (e.g., On Monday last week, user u's geographical context was Paris, whereas today it is Zurich) is not lost but stored in the ESNP using an appropriate encoding, which depends on the context information deemed relevant by other users. A computer-implemented method for implementing context-aware electronic social networking according to an embodiment of the present invention will now be described below with reference to FIG. 2.

In FIG. 2, at operation 200, context information is dynamically obtained for each of a plurality of users, wherein the context information corresponds to at least one of past, present, and future events associated with each user of the plurality of users within the ESN. According to an embodiment of the present invention, the context information for each user may be obtained in any of several different ways. Further, according to an embodiment of the present invention, the type and amount of context information corresponding to each respective user may be preset by the respective user. For example, according to one embodiment of the present invention an user may set context information manually, e.g., user u switches ‘mood’ from ‘sad’ to ‘happy’, user u rates his contact u′ as “highly valuable”. This kind of context switching may be performed using an instant messaging application, e.g., by changing the state from ‘busy’ to ‘available’ in SameTime™. Alternatively or additionally, manual setting may be realized using a Web-based interface. Thus, the present invention is not limited to performing manual setting of context information in any particular manner and therefore, any suitable manner may be utilized.

According to another embodiment of the present invention, context information may be received as input from external applications under user control such as an e-mail client, calendar, etc. This information may be communicated through, for example, an external messaging system, well-defined interfaces, or call-back functions. For example, the context information that a user is currently writing an e-mail can be obtained from a combination of frequent keyboard activity in combination with an active e-mail application. This functionality may operate by connecting a user portion of a system with the external application over a network. In case of a dedicated client application, the client may be hooked into the email system of the user, or even offer the email client in an integrated manner.

According to yet another embodiment of the present invention, the context information may be inferred from other available information, for example, the mood of a user could be inferred from a bio-medical sensor registering the blood-pressure, the heart-beat, or the electrical conductivity of the skin (this is similar to the ‘external application’ discussed above). This inferring can be performed using inference rules in an appropriately expressive calculus on any form of appropriate input data, e.g., sensor data or data from local applications. A reasoning engine may be on the user side, the server side, or both sides.

According to another embodiment of the present invention, predefined/default settings may also constitute context information, e.g., by default, the ‘societal status’ and ‘time’ context on every working day from 08:00 am to 12:00 am and from 01:00 pm to 05:00 pm is set to ‘business’ and ‘working time’, while time after 05:00 pm is set to ‘private’ and ‘leisure time’, and time between 0:00 am and 07:00 am is set to ‘private’ and ‘sleeping time’. This kind of context information may be realized by any interface to the ESN system.

According to another embodiment of the present invention, the context information may be obtained from a third party website. For example, a flight and hotel booking on a partner website may be obtained by using a standardized event format operating on a mutually agreed event ontology. Context information obtained from third parties is provided to the ESNP based on pre-defined agreements between the affiliated third parties.

According to another embodiment of the present invention, the context information may be obtained using a sensor e.g., an accelerometer, a pulse sensor, or a global positioning sensor/receiver (GPS). For example, if user u is traveling at 120 km/h from that information, context information may be inferred such as user u is traveling by train/car based on the speed of which the user u is traveling. Sensors typically are integrated with a user's client system, that is, a dedicated client or a Web-based client via plug-ins. A dedicated system process on one or multiple of the user's devices may be utilized that solicit and manage the sensor data.

According to another embodiment of the present invention, the context information may be obtained using a virtual sensor e.g., software-based network sensors e.g., registering IP subnet, etc which may retrieve event monitoring patterns. Such a context source can, e.g., be used to automatically set the location context of a user to ‘work’ for example. Virtual sensors can leverage available virtual sensors, such as ones available in the user's system or deploy their own virtual sensors for soliciting specific data. User devices may form ad-hoc networks in order to exchange relevant data, such as sensor data for inferring a current context. This is important for user devices that cannot connect themselves to the ESNP directly via the Internet or another suitable communication network. Once the context has been set, the further operations on the contexts, like the operations of the inference and recommendation system, are implemented by the platform.

From operation 200 in FIG. 2, the process moves to operation 210 where the obtained context information is stored in a storage recordable medium as depicted in FIG. 3, for example. From operation 210, the process moves to operation 220, where one or more context patterns of interest are defined using the stored context information. According to an embodiment of the present invention, context patterns of interest may be patterns or similarities in interests between a plurality of users within the ESN. For example, one user may want to be informed when his or her closest contacts are in a same geographical location as the user or have previously visited the same geographical location for which the user is planning to visit, for example. From operation 220, the process moves to operation 230, where at least one context pattern of interest is detected from the one or more context patterns of interest defined for a first user of the plurality of users and one or more recommendations for the first user are formulated using the detected context pattern and the context information for at least a second user of the plurality of users.

According to an embodiment of the present invention, the definition of context patterns of interest (operation 220) and the formulation of recommendations (operation 230) may be performed using any client. The management of these items is performed by the ESNP. The context patterns of interest can be predefined by the ESN or predefined by users or both. Recommendations can be formulated using recommendation information that is predefined by users, recommendation information that is determined by the ESN, or both. Thus, the method of FIG. 2 utilizes past, present, and future context information to provide and inform at least a second ESNP user about relevant past, present, and future moods, activities, location, time zone, and other geographic information for a first ESNP user, and to provide suggestions to these first and second users based on the context information.

According to an embodiment of the present invention, a system for providing recommendations based on inferences may be implemented as a real-time monitoring system that operates on the past, present, and future context information of a plurality of users. The language in which the rules are defined is, as mentioned above, a language that can express conditions over all context, attribute, rating, and other information associated with each user which is available in the ESN. The language allows for the expression of time. The system may be implemented on a server system (as depicted in FIG. 1, for example) and distributed over a plurality of servers in order to achieve load balancing within the system.

According to an embodiment of the present invention, as each user of the plurality of users at any point in time is in a number of contexts as explained above, the ESNP makes inferences and generates recommendations to one or more of the users, such as a first user, based on past, present, and future context information of one or more other users, such as a second user. Recommendations are derived from one or many portions of past, present, and future context information and also take into account general preferences and privacy settings of the individual users. Examples for such context-based recommendations as follows:

A user u who is in the context ‘mood:happy but bored’, ‘time: spare time; time: free calendar’, and ‘location: Zurich’, and is a first-level contact of another user v, who is in the context ‘time: holiday; time: free calendar time’ and ‘location: Zurich’ would be brought to user v's attention providing a suggestion of going for drinks at a bar called ‘Barfly'z’, which is close to users u and v, and which u and v both like as indicated in context information stored based on previous ratings. The ESNP would then generate a recommendation for user u to meet user v by, for example, automatically initiating a phone call between users u and v, automatically opening a messaging dialog between users u and v, sending a text message from user u to user v or vice versa, or sending a meeting invitation to user u and user v, in order to arrange such a meeting. If user u switches his ‘mood’ from ‘happy’ to ‘sad’, user might be offered to e.g., write his thoughts down into a myDiary application, for example, on his PDA or laptop computer, call a friend from his first-level contacts, join a discussion group of other ‘sad’ people, or write an anonymous e-mail to a psychotherapist, etc.

Further, according to an embodiment of the present invention, user u who is planning a trip to a particular city, for example, London, may be informed that his direct contact u′ has three contacts who live and work in London and who enjoy meeting new people or that his contacts a, b, and c have jointly visited London within the previous month and that they enjoyed the ‘Tate Modern’, the ‘Tower Bridge’, and the Club ‘Electronix’, or that his contacts d, e, and f have spent the night at “cheap, cozy, and centrally located hostel Annie”, which his contacts d, e, and f all rated with 4 out of 5 rating stars, and offer to make a reservation in by prompting the user u to select ‘make a reservation’, for example, and provide directives.

The implementation of the above-described inference and recommendation functionality with reference to operations 220 and 230 will now be described below. According to an embodiment of the present invention, there are at least two options for defining context patterns of interest (operation 220) however the present invention is not limited hereto. According to one embodiment, the context patterns of interest may be predefined by the ESNP. In this embodiment, users may opt in or out of being notified when such context patterns occur. Opting in or out to specified context patterns can lead to recommendations of the ESNP to the user of also opting in or out of other related context patterns. Related context patterns may also be registered automatically for a user based on his previous registrations and usage of the ESN. According to another embodiment, the context patterns may be defined by users while taking privacy into account. Users may do so using a temporal property specification language, where the user interface is implemented using visual check-boxes per contact, for example, in order to keep the language manageable.

According to an embodiment of the present invention, as mentioned above, once the context patterns of interest are defined in operation 220, at least one context pattern of interest is detected for the first user and one or more recommendations for the first user are formulated using the detected context pattern of interest and the context information of at least a second user of the plurality of users (operation 230). Further, predefined actions by ESNP with users selecting specific recommendations or recommendation categories of interest and linking them with context patterns or pattern types or user-defined actions, e.g., definable using scripting language, a graphical-interface-based method for programming the actions etc, may be executed. An example of a user-defined action would be to automatically notify another user of the first user's geographical location in case the other user happens to be in the vicinity.

According to an embodiment of the present invention, the process of formulating recommendations involves determining when a certain context change is relevant for which group of users. Typically, the stronger the connection between two users u and v (as indicated by e.g., a direct connection, a high rating, etc.), the more important the context information of u is for v and vice versa. A higher ‘contextual information priority’ is then associated with new context information. While there may be a default setting handling priority, each user should also be able to deploy some priority rules that define this priority in detail. Furthermore, the recommendation process determines when certain context information about a user u is relevant to another user v independent of their connection strength. For example, the context information ‘location.city: Paris’ of a first user u is typically deemed relevant for a second user v if and only v's according context information is also ‘location.city: Paris’. According to an embodiment of the present invention, the context information may not be current context information and instead, may be either past or future context information. According to an embodiment of the present invention if user v is equipped with a GPS device that feeds coordinates into the ESNP, the context information ‘location.coordinates: 48° 52′0.N, 2° 19′59.E’ is converted to ‘location.city: Paris’ to make the information relevant. For every user u, the system computes the (normalized) relevance of context-based information and prioritizes its recommendations to the respective user accordingly.

The following is an example where context-aware electronic social networking is applied in accordance with embodiments of the present invention. The following description assumes that ESNP users' privacy settings permit a sharing of their personal information.

User u is planning a private trip to Paris and “tentatively reserves” some time in a calendar software application on her laptop computer. This time becomes “reserved”, as opposed to tentatively reserved, at the time the flight is booked. All of the user u's ESN contacts who have indicated an interest in the whereabouts of user u (e.g., by setting their ESNP preferences accordingly), will then be notified of the fact that user u is planning a trip to Paris (e.g., through an e-mail, an entry in their news feed, etc.). If some of user u's contacts or contacts of user u's contacts (1) have just been in Paris, (2) are also going to be in Paris at the same time as user u, or (3) are planning individual trips to Paris for some time after user u, user u will also be notified of this information. If some of user u's contacts have visited Paris some weeks ago and spent the night in a nice youth hostel that they liked and rated accordingly, this information is offered to Ava as a suggested place to stay.

If some of user u's contacts are also planning a trip to Paris, the methods disclosed herein propose a recommendation that all user u and user u's contacts plan all or a portion of the trip together, or propose a recommendation that all of them could meet at one or more times that are not booked or set aside as being busy in their calendars. The recommendation may also include a suitable place for the meeting based on the present or anticipated locations of user u and user u's contacts as indicated in stored context information, such as recommending that they have lunch together on Tuesday at 1 pm in Café Figaro near the Bois de Boulogne. Moreover, if user u's contacts are planning individual trips to Paris at some later time, they will automatically keep track of relevant information from user u's side, for example, by obtaining hotel rating information from user u and receiving user u's suggestions regarding restaurants, bars, disco tips, places to visit, and places to avoid. Similarly, once user u wanders around the streets of Paris, using location information (e.g., telecommunication cell-based, GPS-based, etc.), user u would be informed of contacts or places recommended by user u's contacts within the vicinity.

The above-example demonstrates how the methods of implementing context-aware electronic social networking according to embodiments of the present invention as disclosed herein support a user whose context is related to the contexts of other users in a defined and formally evaluable way. Today, many opportunities for social contact (e.g., meeting old friends that happen to be in the same city) are frequently missed because making the relevant context information available would involve considerable communications overhead. In contrast, automatically making relevant context information available to the right people at the right time can considerably increase the value that a user gets from using an ESN.

Overall, the methods disclosed herein create substantial added value for users of ESNs due to the exploitation of information managed by the ESN. The information integration with many sources outside of the ESN is performed on a user-consent basis and allows for a plethora of different information sources to bring information into the ESN. Value is added by the ability of the ESN to use context information to leverage other users' experiences and knowledge for users without requiring lots of additional communication actions by the users. As ESN users define the kind of context information about other users that they are interested in, the methods disclosed herein also avoid communicating unsolicited information and recommendations, thereby contributing to a more positive social interaction experience.

FIG. 3 is a schematic block diagram of a general-purpose computer suitable for practicing the present invention embodiments. In FIG. 3, a computer system 300 has at least one microprocessor or central processing unit (CPU) 305 that processes information for implementing context-aware social networking for an electronic social network (ESN) by obtaining context information for each of a plurality of users, wherein the information is represented, e.g., on a signal bearing medium and is communicated to the computer 300. The processor 305 may implement instructions for obtaining the context information by one or more of: receiving context information from one or more user applications, receiving context information from a third party website, inferring context information from one or more sensor inputs, or predefining the context information by associating the context information with one or more prescheduled events. The obtained context information is stored in a computer readable storage medium. The CPU 305 is interconnected via a system bus 310 to a random access memory (RAM) 315, a read-only memory (ROM) 320, an input/output (I/O) adapter 325 for a connecting a removable data and/or program storage device 330 and a mass data and/or program storage device 335, a user interface adapter 340 for connecting a keyboard 345 and a mouse 350, a port adapter 355 for connecting a data port 360 and a display adapter 365 for connecting a display device 370.

ROM 320 contains the basic operating system for computer system 300. The operating system may alternatively reside in RAM 315 or elsewhere as is known in the art. Examples of removable data and/or program storage device 330 include magnetic media such as floppy drives and tape drives and optical media such as CD ROM drives. Examples of mass data and/or program storage device 335 include hard disk drives and non-volatile memory such as flash memory. In addition to keyboard 345 and mouse 350, other user input devices such as trackballs, writing tablets, pressure pads, microphones, light pens and position-sensing screen displays may be connected to user interface 340. Examples of display devices include cathode-ray tubes (CRT) and liquid crystal displays (LCD).

The configuration of FIG. 3 may optionally include hardware or software for running the ESNP. That is, a server-centric architecture using a cluster of servers which run the server applications constituting the ESN may be employed. In this embodiment, the interface for users is a browser-based interface or an interface using a client for the ESNP, or a mix of both. For example, the client can be used to connect to the user's applications and sensors and solicit data to infer the context of the user and the Web-based interface can be used to perform all other user interactions as in all ESNs. The browser-based interface is preferably realized using Asynchronous JavaScript and XML (AJAX) technology to allow for asynchronous refreshing of parts of the page content. Specific clients or tailored Web interfaces are available for different user devices in order to align with the computational, memory, and display power and size of the devices. Envisaged devices are smart phones, PDAs, and laptop and desktop systems. Future client platforms will probably offer opportunities for running a client system as well.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

The foregoing exemplary embodiments may be provided in the form of computer-implemented processes and apparatuses for practicing those processes. The exemplary embodiments can also be provided in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be provided in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the exemplary embodiments. When implemented on a general-purpose microprocessor, the computer program code segments execute specific microprocessor machine instructions. The computer program code could be implemented using electronic logic circuits or a microchip.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A computer-implemented method for performing context-aware social networking within an electronic social network, the method comprising:
dynamically obtaining context information corresponding to at least one of past, present and future events associated with each user of a plurality of users within the electronic social network;
storing the obtained context information;
defining one or more context patterns of interest using the stored context information; and
detecting a context pattern of interest from the one or more context patterns of interest for a first user of the plurality of users and formulating one or more recommendations or executing user-defined actions or predefined actions by the electronic social network for the first user using the detected context pattern of interest and the context information of at least a second user of the plurality of users.

2. The computer-implemented method of claim 1, wherein the context information is manually set by each respective user.

3. The computer-implemented method of claim 1, wherein the context information is from one or more user applications.

4. The computer-implemented method of claim 1, wherein the context information is obtained from a third party website.

5. The computer-implemented method of claim 1, further comprises inferring the context information from one or more sensor inputs, or predefining the context information by associating the context information with one or more prescheduled events.

6. The computer-implemented method of claim 1, wherein defining the context patterns of interest comprises predefining the context patterns of interest via the electronic social network.

7. The computer-implemented method of claim 1, wherein defining the context patterns of interest comprises predefining the context patterns of interest by each respective user of the plurality of users.

8. The computer-implemented method of claim 1, wherein formulating the one or more recommendations comprises formulating the one or more recommendations using recommendation information that is predefined by each respective user of the plurality of users, recommendation information that is determined by the electronic social network, or both.

9. A computer program product comprising a computer useable medium including a computer readable program, wherein the computer readable program when executed on a computer causes the computer to implement a method for performing context-aware social networking within an electronic social network, the method comprising:
dynamically obtaining context information corresponding to at least one of past, present and future events associated with each user of a plurality of users within the electronic social network;
storing the obtained context information;
defining one or more context patterns of interest using the stored context information; and
detecting a context pattern of interest from the one or more context patterns of interest for a first user of the plurality of users and formulating one or more recommendations or executing user-defined actions or predefined actions by the electronic social network for the first user using the detected context pattern of interest and the context information of at least a second user of the plurality of users.

10. The computer program product of claim 9, wherein the context information is manually set by each respective user.

11. The computer program product of claim 9, wherein the context information from one or more user applications.

12. The computer program product of claim 9, wherein the context information obtained from a third party website.

13. The computer program product of claim 9, wherein the method further comprises inferring the context information from one or more sensor inputs, or predefining the context information by associating the context information with one or more prescheduled events.

14. The computer program product of claim 9, wherein defining the context patterns of interest comprises predefining the context patterns of interest via the electronic social network.

15. The computer program product of claim 9, wherein defining the context patterns of interest comprises predefining the context patterns of interest by each respective user of the plurality of users.

16. The computer program product of claim 9, wherein formulating the one or more recommendations comprises formulating the one or more recommendations using recommendation information that is predefined by each respective user of the plurality of users, recommendation information that is determined by the electronic social network, or both.

17. A system comprising:
a plurality of user interfaces;
a network; and
a processing unit in communication with the plurality of user interfaces via the network, wherein the processing unit is configured to:
dynamically obtain context information corresponding to at least one of past, present and future events associated with each user of a plurality of users within the electronic social network;
store the obtained context information;
define one or more context patterns of interest using the stored context information; and
detect a context pattern of interest from the one or more context patterns of interest for a first user of the plurality of users and formulate one or more recommendations or execute user-defined actions or predefined actions by the electronic social network for the first user using the detected context pattern of interest and the context information of at least a second user of the plurality of users.

18. The system of claim 17, wherein the context information is manually set by each respective user via the user interfaces.

19. The system of claim 17, wherein the context information is from one or more user applications.

20. The system of claim 17, wherein the context information is obtained from a third party website.
